(19) United States
(12) Patent Application Publication
(10) Pub. No.: US 2006/0244313 A1
(43) Pub. Date: Nov. 2, 2006

(54) Safety systems for automobiles

(76) Inventor: Scott L. Sullivan, (US)

Correspondence Address: Scott L. Sullivan, 634 Homer Ave. (#2), Palo Alto, CA, 94301, US

(21) Appl. No.: 11/412,848

(22) Filed: Apr. 27, 2006

Related U.S. Application Data
(60) Provisional application No. 60/676,487, filed on Apr. 28, 2005.

(51) Int. Cl. B60L 1/00

(52) U.S. Cl. 307/9.1

(57) ABSTRACT

An automotive safety system is includes a power window that is automatically lowered a prescribed distance from a fully raised position in response to the car being put into reverse so that the driver may hear outside sounds. According to a second embodiment, the radio system is also turned down when the car is put into reverse.

### CLAIM OF PRIORITY

Applicant hereby claims priority based on Provisional Patent Application No. 60/676487, filed Apr. 28, 2005 and entitled: “Various Kitchen Products, Automotive, Power Cord-Cover, Cell Phone Systems, Furniture, and a Traffic Light.” The content of the above-listed provisional patent application in its entirety is hereby incorporated by reference.

### BACKGROUND OF THE INVENTION

a) Field of the Invention

This patent application generally relates to automotive safety, and more particularly, to safety improvements relating to automotive window systems.

b) Description of the Prior Art

There are a variety of automotive-related safety devices. Many of which are directed to protecting occupants during and after a crash. Some prior art safety devices help warn a driver that an obstacle is located directly behind the automobile when the vehicle is backing up.

### SUMMARY OF THE INVENTION

An automotive safety-system includes a power window that automatically lowers a prescribed distance from a fully raised position in response to the car being put into reverse so that the driver can better hear outside sounds.

According to a second embodiment, the radio system is also turned down when the car is put into reverse.

### DETAILED DESCRIPTION OF THE EMBODIMENTS

Automobile Idiot Light Management

Another invention relates to an engine control unit (ECU) and a body control unit (BCU) used onboard automobiles to help read the various sensors located within a typical automobile. Both the ECU and the BCU constantly interrogates the various sensors and uses the received information to control the various components within the automobile. If a particular sensor sends data that is beyond a predetermined “safe” or “normal” range of operation, the ECU will send an “on” signal to a “check engine” light located on the dashboard of the car. This is the computer's way to communicate with the driver that something is wrong with the car and that the car should be checked out.

To help reduce cost and complexity of automobiles and to discourage non-professional people, e.g., the typical driver from getting too involved trying to locate and repair the troubled part, the communication of “trouble” remains very simple and “idiot”-proof, which is why the light is typically called an “idiot light”. When the light turns on, the driver should bring the car to a professional to fix the car.

When there is a problem with some part of the engine, or car, the ECU does know which part is broken or has malfunctioned and the professional may access this critical detailed information using appropriate diagnostic computer-reading equipment. The driver remains, well, he remains an “idiot”, in that he or she may never know the details of the problem, until they read the mechanic's invoice.

A problem arises with this overly simply warning-light arrangement. The warning light remains the same regardless if the car is experiencing serious trouble (which requires that the driver pull over immediately to avoid serious damage to the engine) or just routine maintenance which can be corrected any time.

According to the present invention, the information already stored in the memory of the ECU is used to control the simple “idiot light” to help indicate the urgency of the particular problem. For example, the light could blink in response to the level of seriousness detected by the ECU. In such instance, in this example, according to the invention, the more serious the problem detected by the ECU, the brighter and more quickly the warning light on the dash will blink. The light could include three different colors (three lights): one red light to indicate a serious problem, one yellow light to indicate a non-serious problem, and perhaps a green light to indicate that a scheduled maintenance is required (within a month or two). Alternately, another light could be used to indicate a serious problem, such as one that includes the text: “CHECK ENGINE—PULL OVER NOW”.

Automotive Window Controller

Several problems exist in any car that uses motorized windows of the type wherein a drive motor located within a door assembly is selectively powered through an appropriate electrical switch by a user to raise or lower a door-mounted window, as desired by the user. In normal operation, the user activates a momentary switch to a “raise” position, which powers a window drive-motor and raises the window to its limits. When the window reaches a fully-closed position, the user releases the switch so that the motor is no longer powered. The motor, drive and lifting mechanism can become damaged, or otherwise prematurely warn, overtime if the user continues to power the motor after the window has reached the end of its range of movement in any particular direction, but in particular, in the fully-raised position. When the user is preoccupied or is raising more than one window at a time (the driver has switch controls for all the powered windows of the car), the user may not release the particular switch for a particular window motor and damage may result over time.

To overcome this problem, according to this invention, a sound activates when the any particular window reaches the extent of its range, thereby indicating to the user that the switch should be released and/or a tactile response at the switch itself, which would similarly indicate to the user that the particular window is completely closed. According to another embodiment of this invention, an appropriate current-measuring circuit is integrated into the drive motor circuit so that the current draw of each window drive-motor is measured and the circuit could be deactivated whenever the measured current exceeds a predetermined amperage. The predetermined amperage can vary over time to account for the age of the drive motor (older motors will likely use more current than newer ones). Also, a circuit can be used to measure the current draw of each motor over time so that a changing average current draw is “learned” by the circuit and constantly updated. In operation, once the current threshold is reached, the window will stop and cannot be moved any further in the same direction, but can be moved in the opposite direction.

Power-Window Safety Control

Another problem relating to automotive power windows relates to child-safety. Each year, several children and many dogs, are fatally injured by car windows being accidentally raised against their bodies (and their wishes) as they lean out through an open window. Apparently, the unknowing child or pet accidentally steps on (with their knee, hand, paw, or foot) or otherwise contacts the raise-window switch located on the armrest of the car when they are leaning out the open window. As the window raises and contacts their body or neck, panic sets in and in the confusion, they overlook the fact that they are just stepping on the window switch and could likely save themselves by merely moving off the switch.

To overcome this problem, a selectively activated sound circuit creates an audible alarm (or other appropriate sound or light or indication) whenever a back seat window is activated, either up or down. This could include immediately turning down or off the radio (or other sound generating device) for a period of time as the window is being raised.

Alternatively, according to a second embodiment of the invention, to overcome this power-window, child-safety problem, a circuit defaults the control of the rear-seat power windows to a “child-safe” mode. In this mode, the rear-seat windows are either deactivated completely or can only be operated within a predetermined range of movement, such that a child's body or a pet's body would not be injured if the window was raised to it's uppermost range of the limited range of movement. The rear windows, in this mode, could only be fully raised from the driver's seat position by the driver.

According to another embodiment of the invention to solve this car-window, child-safety problem, a current-measuring circuit is used (or any electrical or mechanical load measuring device or system) to measure the current draw of the motor when the motor is raising a particular window. When the motor is raising a window, more torque is required and the current draw will be higher than when the motor is lowering the same window since there is generally more resistance and also a greater load (the weight of the window, etc.). The motor requires more current to move the greater load. If the window, as it is being raised contacts an obstacle, such as an arm or neck of a child, the measured current will rise very fast.

According to this embodiment of the invention, the relative location of the upper edge of the window is detected (using an appropriate known system) so that if the top edge of the window is not completely within the upper channel (or located very close to the top—⅛ to ¼ inch if a channel structure is not used with the particular window) and the current of the motor increases past a predetermined level, the motor will automatically deactivate and reverse to a fully down position and perhaps an alarm or the car's horn will sound. If the window is at it's fully (or very close—within perhaps around ⅛ inches) raised position and the upper edge of the window is within the receiving channel located along the perimeter of the window frame of the door, then the window motor will be allowed to continue operation regardless of the measured current. This is because within this location within the frame it is expected that measured current of the drive motor will increase as the window edge seats tightly within the window receiving channel and a child's fingers, arms, neck, etc cannot fit into this small space. A sensor (such as an optical-coupler) can be used to measure relative rotation of a particular drive gear or other rotational part of the drive mechanism to determine the relative distance between the upper edge of the window and the upper most surface of the receiving channel so that the location of the upper edge of the window can be known to the circuit. An appropriate current measuring circuit may be used to initially learn the range of motion of the particular window during a calibration period, perhaps at the factory.

Alternatively, according to yet another embodiment of the invention, a pressure-sensing switch could be located within the window-receiving channel so that if an obstacle is present between the upper edge of a rising window and below the upper window-receiving channel, the pressure switch will activate (pre-set to a particular switching pressure). This will cause the window drive motor to be reversed (or at least immediately deactivated) and an alarm will sound and a light will activate in the driver's view and the radio, if it is on will be turned off or it's sound volume attenuated so that the driver will notice the potentially dangerous condition.

According to another embodiment of the invention here, a power switch to control a rear-seat power window may include an adjacent pressure switch so that if a child or a pet accidentally presses onto the overall switch assembly, the area located adjacent to the switch will “measure” a load by the child's or pet's weight. This measured load can be used to deactivate the drive motor so that only a user who intends raising the window and uses only his or her fingers will be able to overcome this safety cutout circuit. The pressure switch may be conventional and is preferable incorporated within the window-control switch assembly so that assembly remains economical. The cutoff switch portion of the window switch could be incorporated into the switch lever itself so that if the user pushes down a first amount, the window switch will activate and power will cause the motor to raise the window. However, if the user pushes the switch lever down too hard to a second amount, the switch will cutoff power to the window drive motor and the window will stop moving and perhaps would have to be reset by an adult.

Reverse Safety Control

Another safety-related problem regarding car windows occurs whenever the windows are all the way up and closed. When the windows seal out the elements of the outside world, they also severely attenuate outside sounds. This results in a loss of environment information, which is often necessary for the driver to safely operate the car. Ambient sound may be less important when a car is being driven on an open highway, for example because he or she can see much of the environment as he or she drives forward. However, sound becomes critical when the other senses of a driver cannot be relied upon for various reasons. For example, when a driver backs out from a garage and threatens to drive over a toy or hit a child, the driver must be capable of hearing any distress alert from the child, a witness, or hear any contact sound (from the toy or child or pet) so that appropriate action can take place before damage is done to either the car or the item or person or pet being hit. Since closed windows would muffle any such sounds (even when a car's radio is off), the driver runs the risk of inadvertently harming a person or animal or unnecessarily damaging their car under certain situations.

To overcome or at least minimize this problem, according to this invention, Applicant proposes introducing a simple control circuit to the power windows that causes at least the driver's window to be automatically lowered a prescribed amount, preferably between ⅛ and ½ inch—only if the select window is at its fully closed position, and whenever the car is put into reverse. This will allow the outside warning sounds to enter the driver's ears clearly without unduly effecting the comfortable environment within the car (i.e., the lowered window will not let in rain or cold or wind in any appreciable amounts). All windows or any combination of windows may be lowered according to this invention.

In most cases, this invention may be easily and quickly implemented to conventional automobiles by introducing controlling software to the window-control portion of the body control unit (BCU). The software detects a reverse condition (i.e., the car has been put into reverse) and further detects that the driver's side window is at its upper (closed) position before sending a signal to the driver's side window drive motor to lower the window for a prescribed time period (a fraction of a second) so that the driver's side window remains about ⅛″ to ½″ down (or whatever distance is required to allow sufficient sound penetration from the outside to the driver's ear).

Preferably, a sensor (or sensing circuit) is used to determine if the driver's window is at its fully up and closed position and additionally when the window is at a preset partially lowered position (e.g., ¼− to ½″ down). To help indicate when the window is at these positions, a simple positioning device is used in connection with either the drive motor for the window or any of the drive mechanisms used to control the window, such as a pressure switch or an electro-optical device.

According to another aspect of this invention, the car's radio (or sound system) automatically shuts off or its speaker volume is attenuated whenever the car is put into reverse so that outside sounds can be better heard. This invention may be used in combination with the above-described one wherein both the driver's side window is lowered a small amount AND the radio/sound system volume is lowered whenever the car is put into reverse.

According to another safety related invention, if a rain-detector (could be conventional, such as the one disclosed by U.S. Pat. Nos. 6,392,218, 6,603,137, and 6,806,485) determines that it is raining, then a rear-window wiper (if there is one) automatically activates whenever the car is put into reverse so that the driver will be assured a clear view as he or she backs the car up. The “rain-detector” could simply be whenever the front-windshield wipers are turned on, the rear wiper turns on when the car is put into reverse and turns off when the car is taken out of reverse gear.

According to another invention, a flash strobe (such as the type shown in U.S. Pat. No. 6,483,254) is included somewhere on the backside of a car and is activated at prescribed intervals whenever the car is in “reverse” (i.e., whenever the conventional reverse lights are illuminated). The strobe preferably flashes at a rate of about 1 flash per second, but the rate can be dynamic, flashing at a faster rate if the car is moving faster and/or flashing at a faster rate if any onboard proximity circuit detects an object. Unlike the strobe disclosed by the above-identified '245 patent, the present strobe assembly is located immediately adjacent to the conventional reverse lights (at least one of the two lights) within the same housing so that the styling of the car can be maintained.

According to another invention, in cars that include a proximity sensing system wherein a device will detect the presence of an object located directly in the path of reversing car, Applicant proposes introducing a sound generator outside the car, preferably at the rear bumper of the car (the potential point of impact). This is to help warn any child or person or pet that a car may hit them soon. The sound generator may be a horn, a beep sound (like the beeping sound used with trucks backing up) or a synthesized voice sound such as (“LOOK OUT” or “MOVE”).

According to another invention, a microphone circuit could be provided to pick up sounds located in the rear portion of a car and the signal either merely amplified and broadcast to the driver so that he or she can clearly hear any sounds of distress as the car backs up in reverse. To prevent confusing the driver, the incoming sound signal can be inputted into the car's stereo system and the signal can be separated and delivered to the speakers of the car according to where the sound originated outside the vehicle. For example, if a child is shouting “stop” outside the car on the right side of the car, the “stop” sound will be sent to the right rear speaker of the car's stereo system. The driver will then know immediately where the danger is and can react accordingly.

Also, the picked up sound signals from outside the vehicle can be sent to a speech recognition circuit wherein predetermined known sounds of distress can be detected and perhaps the brakes of the car automatically applied or a loud alarm can sound. For example, if the words “STOP”, “HEY”, “WAIT”, “DAD”, “MOM” or words like that are sensed, action may automatically be taken and an alarm may sound or the car's brakes may automatically be activated.

What is claimed is:

1. A method for increasing audible awareness to the driver of a vehicle when the vehicle is engaged to move in a reverse direction, said method comprising the steps of:
detecting when said vehicle is put into reverse gear;
detecting the vertical position of at least one moveable window of said vehicle, said window being mechanically driven by a drive motor so that said window can be selectively displaced between a fully raised position and a fully lowered position;
powering said window down a predetermined distance in response to said first detecting step detecting that said vehicle is in reverse gear and said second detecting step detecting that said window is at said fully raised position.
